(19) United States
(12) Patent Application Publication
(10) Pub. No.: US 2012/0196116 A1
(43) Pub. Date: Aug. 2, 2012

(54) GYPSUM WALL BOARD CONTAINING MICRO-ENCAPSULATED LATENT HEAT ACCUMULATOR MATERIALS

(75) Inventors: Hans Willax, Maxdorf (DE); Britta Katz, Dannstadt-Schauernheim (DE); Marc Rudolf Jung, Worms (DE); Stephan Altmann, Ruppertsberg (DE); Ekkehard Jahns, Weinheim (DE)

(73) Assignee: BASF SE, Ludwigshafen (DE)

(21) Appl. No.: 13/499,502

(22) PCT Filed: Sep. 28, 2010
(86) PCT No.: PCT/EP10/64349

§ 371 Date: Mar. 30, 2012

(30) Foreign Application Priority Data
Oct. 2, 2009 (EP) 09172063.1

(51) Int. Cl. B32B 5/16; B05D 7/00; F26B 5/00; B05D 3/12; B05D 3/02; C09K 5/06; B05D 3/00

(52) U.S. Cl. 428/323; 252/70; 427/289; 34/329

(57) ABSTRACT

The present invention relates to a gypsum construction board comprising two covering layers and a gypsum core, where the gypsum core comprises microcapsules with a lipophilic capsule core and a capsule wall formed from
30 to 100% by weight, based on the total weight of the monomers, of one or more monomers (monomers I) selected from C₁-C₂₄-alkyl esters of acrylic and methacrylic acid, acrylic acid, methacrylic acid and maleic acid,
0 to 70% by weight, based on the total weight of the monomers, of one or more monomers with at least two nonconjugated ethylenic double bonds (monomers II), which is insoluble or sparingly soluble in water, and
0 to 40% by weight, based on the total weight of the monomers, of one or more other monomers (monomers III),
and at least one polymer P, which has a glass transition temperature T_{g} in the range from −60 to 160° C., and also a method for its production.

The present invention relates to a gypsum construction board comprising two covering layers and a gypsum core, where the gypsum core comprises microcapsules whose capsule core is a lipophilic substance and whose capsule wall is a polymer based on acrylic and/or methacrylic acid or esters thereof, and to a method for its production.

In recent years, there have been diverse developments in the field of microencapsulated latent heat storage media. The applications range from packaging materials, textiles, heat transfer liquids to construction materials such as gypsum construction boards. The mode of function of the latent heat storage media, often also referred to as PCM (phase change material), is based on the conversion enthalpy which occurs during the solid/liquid phase transition and which signifies an absorption of energy or release of energy into the surrounding area. They can therefore be used for keeping the temperature constant within a fixed temperature range. For example, gypsum construction boards comprising microencapsulated latent heat storage materials permit a passive air conditioning of rooms.

Depending on the field of use, different requirements are placed on the size and tightness of the microcapsules. WO 2006/018130 describes the production of pellets for beds and for applications through which substances flow, such as heat exchangers. The pellets are obtained by extruding a mixture of microcapsules and film-forming polymers.

In construction applications, by contrast, the focus is on microcapsule powders. For example, DE-A-101 39 171 and EP 1 291 475 teach the use of microencapsulated latent heat storage materials in gypsum construction boards. The microcapsule walls are formed by polymerization of methyl methacrylate and butanediol diacrylate in the presence of inorganic solid particles as protective colloid.

The latent heat storage materials used are often organic waxes, which melt upon exceeding the phase transition. If such microcapsules are used in porous construction materials such as gypsum, then a slight escape of waxes can be observed in the case of capsules with inadequate tightness over a prolonged period. However, exudations of this type are undesired, especially in interiors, and so the object of the present invention is lower-emission gypsum construction boards.

One approach to solving this problem is the development of microcapsules whose walls have greater tightness. For example, WO 2008/046839 teaches microcapsules with an additional polyelectrolyte coating, as a result of which the tightness of the capsule wall was increased.

Furthermore, the earlier European application 09165134.9 describes microcapsules with walls formed from methyl methacrylate and pentaerythritol tetraacrylate. By virtue of this novel wall polymer it was possible to achieve an improved evaporation rate in the temperature range from 15 to 105° C.

Nevertheless, the aim was to seek further solutions for making the overall system of gypsum construction board/microcapsules lower-emission. It was therefore an object of the present invention to provide gypsum construction boards comprising microencapsulated latent heat storage materials which exhibit a low emission of latent heat storage material even over a prolonged period.

Accordingly, a gypsum construction board comprising two covering layers and a gypsum core has been found, where the gypsum core comprises microcapsules with a lipophilic capsule core and a capsule wall formed by polymerisation from
30 to 100% by weight, based on the total weight of the monomers, of one or more monomers (monomers I) selected from C₁-C₂₄-alkyl esters of acrylic and methacrylic acid, acrylic acid, methacrylic acid and maleic acid,
0 to 70% by weight, based on the total weight of the monomers, of one or more monomers with at least two nonconjugated ethylenic double bonds (monomers II), which is insoluble or sparingly soluble in water, and
0 to 40% by weight, based on the total weight of the monomers, of one or more other monomers (monomers III),
   and at least one polymer P, which has a glass transition temperature T_{g} in the range from −60 to 160° C., preferably in the range from 60 to 100° C. Furthermore, the application relates to a method for producing the gypsum construction boards.

The application further relates to a microcapsule powder which is obtained by spray-drying an aqueous mixture comprising the aforementioned microcapsules and the polymer P, and to a process for its preparation.

The microcapsules present according to the invention in the gypsum core comprise a lipophilic capsule core and a capsule wall made of polymer. The capsule core consists predominantly, to more than 95% by weight, of lipophilic substance. The average particle size of the capsules (centrifugal average by means of light scattering) is 1 to 50 μm. According to a preferred embodiment, the average particle size of the capsules is 1.5 to 15 μm, preferably 4 to 10 μm. Here, preferably 90% of the particles have a particle size of less than twice the average particle size.

The weight ratio of capsule core to capsule wall is generally from 50:50 to 95:5. Preference is given to a core/wall ratio of 70:30 to 93:7.

The polymers in the capsule wall comprise, in copolymerized form, generally at least 30% by weight, in a preferred form at least 50% by weight and in a particularly preferred form, at least 60% by weight, and also in general at most 100% by weight, preferably at most 90% by weight and in a particularly preferred form at most 80% by weight, of one or more monomers (monomers I) selected from C₁-C24-alkyl esters of acrylic and methacrylic acid, acrylic acid, methacrylic acid and maleic acid, based on the total weight of the monomers.

Furthermore, the polymers in the capsule wall can comprise, in copolymerized form, preferably at least 10% by weight, preferably at least 15% by weight, preferably at least 20% by weight, and in general at most 70% by weight, preferably at most 50% by weight and in a particularly preferred form at most 30% by weight, of one or more monomers with at least two nonconjugated ethylenic double bonds (monomers II), which is insoluble or sparingly soluble in water, based on the total weight of the monomers.

In addition, the polymers can comprise, in copolymerized form, up to 40% by weight, preferably up to 30% by weight, in particular up to 10% by weight, particularly preferably 1 to 5% by weight, of one or more monounsaturated, nonionizable monomers (monomer III), which are different from the monomers I, based on the total weight of the monomers.

Preferably, the capsule wall is formed only from monomers of groups I and II.

Suitable monomers I are C₁-C₂₄-alkyl esters of acrylic and/or methacrylic acid, acrylic acid, methacrylic acid and maleic acid. Preferred monomers I are methyl acrylate, ethyl acrylate, n-propyl acrylate and n-butyl acrylate, and also the corresponding methacrylates. Particular preference is given to isopropyl acrylate, isobutyl acrylate, sec-butyl acrylate and tert-butyl acrylate, and also isopropyl methacrylate, isobutyl methacrylate, sec-butyl methacrylate and tert-butyl methacrylate. In general, the methacrylates are preferred.

Furthermore, one or more monomers with at least two nonconjugated ethylenic double bonds (monomers II) can be copolymerized with the one or more monomers I. Suitable monomers II are insoluble or sparingly soluble in water, but preferably have good to limited solubility in the lipophilic substance. Sparing solubility is to be understood as meaning a solubility of less than 60 g/I at 20° C. At least two double bonds means that the monomers generally have two, three, four or five ethylenic double bonds, preferably vinyl or vinylidene groups. They effect a crosslinking of the capsule wall during the polymerization. It is possible to copolymerize one or more monomers with two nonconjugated double bonds and/or one or more monomers with more than two nonconjugated double bonds.

Suitable monomers with two nonconjugated ethylenic double bonds are divinylbenzene and divinylcyclohexane. Preference is given to the diesters of diols with acrylic acid or methacrylic acid, also the diallyl and divinyl ethers of these diols. By way of example, mention may be made of ethanediol diacrylate, ethylene glycol dimethacrylate, 1,3-butylene glycol dimethacrylate, diethylene glycol diacrylate, dipropylene glycol diacrylate, methallylmethacrylamide, allyl acrylate and allyl methacrylate. Particular preference is given to propanediol diacrylate, butanediol diacrylate, pentanediol diacrylate and hexanediol diacrylate and the corresponding methacrylates.

Preferred monomers with more than two nonconjugated ethylenic double bonds are the polyesters of polyols with acrylic acid and/or methacrylic acid, and also the polyallyl and polyvinyl ethers of these polyols. Preference is given to monomers with three and/or 4 radically polymerizable double bonds. Preference is given to trimethylolpropane triacrylate and trimethacrylate, pentaerythritol triallyl ether, pentaerythritol tetraallyl ether, pentaerythritol triacrylate and pentaerythritol tetraacrylate, and also their technical-grade mixtures.

Other monomers (monomers III) that are different from the monomers I and II that are to be mentioned are monounsaturated monomers, such as vinyl acetate, vinyl propionate, vinylpyridine and styrene or α-methylstyrene, itaconic acid, vinylphosphonic acid, maleic anhydride, 2-hydroxyethyl acrylate and methacrylate, acrylamido-2-methylpropanesulfonic acid, methacrylonitrile, acrylonitrile, methacrylamide, N-vinylpyrrolidone, N-methylolacrylamide, N-methylolmethacrylamide, dimethylaminoethyl methacrylate and diethylaminoethyl methacrylate. Monounsaturated, nonionizable monomers, such as vinyl acetate, vinyl propionate, vinylpyridine and styrene or a-methylstyrene, are preferred.

Preference is given to using microcapsules whose capsule wall is formed from
50 to 90% by weight, based on the total weight of the monomers, of one or more monomers (monomers I) selected from C₁-C₂₄-alkyl esters of acrylic and methacrylic acid, acrylic acid, methacrylic acid and maleic acid,
10 to 50% by weight, based on the total weight of the monomers, of one or more monomers with more than two nonconjugated ethylenic double bonds (monomers II), and
0 to 30% by weight, based on the total weight of the monomers, of one or more other monomers (monomers III).

The microcapsules used according to the invention can be produced by a so-called in situ polymerization. The principle of microcapsule formation is based on using the monomers, free-radical initiator, protective colloid and the lipophilic substance to be encapsulated to produce an oil-in-water emulsion in which the monomers and the lipophilic substance are present as disperse phase. According to one embodiment, it is possible to add the free-radical initiator only after the dispersion. The free-radical polymerization of the monomers is then triggered by heating and optionally controlled by further increasing the temperature, during which the resulting polymers form the capsule wall which surrounds the lipophilic substance. This general principle is described, for example, in DE-A-10 139 171, to the contents of which reference is expressly made.

As a rule, the microcapsules are prepared in the presence of at least one organic and/or inorganic protective colloid. Both organic and inorganic protective colloids may be ionic or neutral. Protective colloids can be used here either individually or else in mixtures of two or more identically or differently charged protective colloids. Preferably, the microcapsules are prepared in the presence of an inorganic protective colloid, in particular in combination with an organic protective colloid.

Organic protective colloids are preferably water-soluble polymers which reduce the surface tension of the water from 73 mN/m maximum to 45 to 70 mN/m and thus ensure the formation of closed capsule walls, and also form microcapsules with preferred particle sizes in the range from 0.5 to 50 μm, preferably 0.5 to 30 μm, in particular 0.5 to 10 μm.

Organic anionic protective colloids are sodium alginate, polymethacrylic acid and its copolymers, the copolymers of sulfoethyl acrylate and methacrylate, of sulfopropyl acrylate and methacrylate, of N-(sulfoethyl)maleimide, of 2-acrylamido-2-alkylsulfonic acids, styrenesulfonic acid and vinylsulfonic acid. Preferred organically anionic protective colloids are naphthalenesulfonic acid and naphthalenesulfonic acid-formaldehyde condensates, and also in particular polyacrylic acids and phenolsulfonic acid-formaldehyde condensates.

Organic neutral protective colloids are, for example, cellulose derivatives, such as hydroxyethylcellulose, methylhydroxyethylcellulose, methylcellulose and carboxymethylcellulose, polyvinylpyrrolidone, copolymers of vinylpyrrolidone, gelatin, gum Arabic, xanthan, casein, polyethylene glycols, polyvinyl alcohol and partially hydrolyzed polyvinyl acetates, and also methylhydroxypropylcellulose. Polyvinyl alcohol and partially hydrolyzed polyvinyl acetates are sold, for example, as Mowiol® grades from Kuraray Specialities Europe (KSE). Preferred organic neutral protective colloids are polyvinyl alcohol and partially hydrolyzed polyvinyl acetates, and also methylhydroxy-(C₁-C₄)-alkylcellulose.

Suitable methylhydroxy-(C₁-C₄)-alkylcelluloses are, for example, methylhydroxyethyl-cellulose or methylhydroxypropylcellulose. Particular preference is given to methylhydroxypropylcellulose. Methylhydroxy-(C₁-C₄)-alkylcelluloses of this type are available, for example, under the trade names Culminal® from Hercules/Aqualon.

The microcapsules are preferably produced by preparing an oil-in-water emulsion comprising, as essential constituents, the monomers, free-radical initiators, inorganic protective colloid and the lipophilic substance to be encapsulated, and triggering the polymerization. Optionally, the polymerization is controlled by increasing the temperature, during which the resulting polymers form the capsule wall, which surrounds the lipophilic substance.

The inorganic protective colloid is preferably inorganic solid particles, so-called Pickering systems. Such a Pickering system can consist here of the solid particles alone or additionally of auxiliaries which improve the dispersibility of the particles in water or the wettability of the particles by the lipophilic phase. The mode of action and their use is described in EP-A-1 029 018 and also EP-A-1 321 182, to the contents of which reference is expressly made.

The inorganic solid particles may be metal salts, such as salts, oxides and hydroxides of calcium, magnesium, iron, zinc, nickel, titanium, aluminum, silicon, barium and manganese. Mention should be made of magnesium hydroxide, magnesium carbonate, magnesium oxide, calcium oxalate, calcium carbonate, barium carbonate, barium sulfate, titanium dioxide, aluminum oxide, aluminum hydroxide and zinc sulfide. Silicates, bentonite, hydroxyapatite and hydrotalcites may likewise be mentioned. Particular preference is given to SiO₂-based silicas, magnesium pyrophosphate and tricalcium phosphate.

Suitable SiO₂-based protective colloids are highly disperse silicas. They can be dispersed as fine, solid particles in water. However, it is also possible to use so-called colloidal dispersions of silica in water. Such colloidal dispersions are alkaline, aqueous mixtures of silica. In the alkaline pH range, the particles are swollen and stable in water. For a use of these dispersions as protective colloid, it is advantageous if the pH of the oil-in-water emulsion is adjusted to pH 2 to 7 using an acid. Preferred colloidal dispersions of silica have a specific surface area in the range from 70 to 90 m²/g at pH 9.3.

Preferred SiO₂-based protective colloids are highly disperse silicas whose average particle sizes are in the range from 40 to 150 nm at pH values in the range from 8-11. By way of example, mention may be made of Levasil® 50/50 (H. C. Starck), Köstrosol® 3550 (CWK Bad Köstritz), and Bindzil® 50/80 (Akzo Nobel Chemicals).

Preference is given to using a combination of an SiO₂-based protective colloid and a methylhydroxy-(C₁-C₄)-alkylcellulose, as described in WO 2009/077525, to the contents of which reference is expressly made.

In general, the protective colloids are used in amounts of from 0.1 to 15% by weight, preferably from 0.5 to 10% by weight, based on the water phase. For inorganic protective colloids, preferably amounts of from 0.5 to 15% by weight, based on the water phase, are selected here. Organic protective colloids are preferably used in amounts of from 0.1 to 10% by weight, based on the water phase of the emulsion. The methylhydroxy-(C₁-C₄)-alkylcellulose used according to one preferred embodiment is used here preferably in an amount of from 0.5% by weight to 1.5% by weight, in particular from 0.6% by weight to 0.8% by weight, based on the SiO₂-based protective colloid.

Free-radical initiators which can be used for the free-radically proceeding polymerization reaction are oil-soluble peroxo and azo compounds generally known to the person skilled in the art, expediently in amounts of from 0.2 to 5% by weight, based on the weight of the monomers. Free-radical initiators of this type are specified in WO 2009/077525, to the disclosure of which reference is expressly made. Furthermore, it is possible to add regulators known to the person skilled in the art to the polymerization in customary amounts, such as tert-dodecyl mercaptan or ethylhexyl thioglycolate.

As a rule, the polymerization is carried out at 20 to 100° C., preferably at 40 to 95° C. Depending on the desired lipophilic substance, the oil-in-water emulsion should be formed at a temperature at which the core material is liquid/oily. Accordingly, a free-radical initiator has to be selected whose decomposition temperature is above this temperature, and the polymerization must likewise be carried out at 2 to 50° C. above this temperature, meaning that free-radical initiators are optionally selected whose decomposition temperature is above the melting point of the lipophilic substance. The reaction times of the polymerization are normally 1 to 10 hours, in most cases 2 to 5 hours.

After the actual polymerization reaction at a conversion of 90 to 99% by weight, it is generally advantageous to render the aqueous microcapsule dispersions largely free of odor carriers, such as residual monomers and other volatile organic constituents. This can be achieved in a manner known per se by physical means by distillative removal (in particular by means of steam distillation) or by stripping with an inert gas. It may also be carried out by chemical means, as described in WO 99/24525, advantageously by redox-initiated polymerization, as described in DE-A 44 35 423, DE-A 44 19 518 and DE-A 44 35 422.

Moreover, in order to reduce the residual monomer content, according to one embodiment, the renewed addition of a free-radical initiator is required, which defines the start of the afterpolymerization. According to one preferred embodiment, after the capsule formation, an afterpolymerization is triggered with ammonium, sodium and/or potassium peroxodisulfuric acid as free-radical initiator.

The salts of peroxodisulfuric acid are water-soluble and trigger the afterpolymerization in the or from the water phase. The salts of peroxodisulfuric acid are expediently used in amounts of from 0.2 to 5% by weight, based on the weight of the monomers. Here, it is possible to meter them in all at once or over a certain period.

If required, the afterpolymerization can also be carried out at lower temperatures by adding reducing agents such as sodium bisulfite. The addition of reducing agents can further lower the residual monomer content.

In this way it is possible to produce microcapsules with an average particle size in the range from 0.5 to 100 μm, it being possible to adjust the particle size in a manner known per se via the shear force, the stirring speed, and its concentration. Preference is given to microcapsules with an average particle size in the range from 0.5 to 50 μm, preferably 0.5 to 30 μm, in particular 3 to 7 μm (centrifugal average by means of light scattering).

The lipophilic substance is preferably a latent heat storage material. According to the definition, latent heat storage materials are substances which have a phase transition in the temperature range in which heat transfer is to take place. Preferably, the lipophilic substance has a solid/liquid phase transition in the temperature range from −20 to 120° C.

Examples of suitable substances are:
aliphatic hydrocarbon compounds, such as saturated or unsaturated C₁₀-C40-hydrocarbons, which are branched or preferably linear, such as n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, and cyclic hydrocarbons, e.g. cyclohexane, cyclooctane, cyclodecane; aromatic hydrocarbon compounds, such as benzene, naphthalene, biphenyl, o- or n-terphenyl, C₁C₄₀-alkyl-substituted aromatic hydrocarbons, such as dodecylbenzene, tetradecylbenzene, hexadecylbenzene, hexylnaphthalene or decylnaphthalene;
saturated or unsaturated C₆-C₃₀-fatty acids, such as lauric acid, stearic acid, oleic acid or behenic acid, preferably eutectic mixtures of decanoic acid with e.g. myristic acid, palmitic acid or lauric acid;
fatty alcohols, such as lauryl alcohol, stearyl alcohol, oleyl alcohol, myristyl alcohol, cetyl alcohol, mixtures such as coconut fatty alcohol, and the so-called oxo alcohols which are obtained by hydroformylation of α-olefins and further reactions:
C₆-C₃₀-fatty amines, such as decylamine, dodecylamine, tetradecylamine or hexadecylamine;
esters such as C₁-C₁₀-alkyl esters of fatty acids, such as propyl palmitate, methyl stearate or methyl palmitate, and preferably their eutectic mixtures or methyl cinnamate;
natural and synthetic waxes, such as montanic acid waxes, montanic ester waxes, carnauba wax, polyethylene wax, oxidized waxes, polyvinyl ether wax, ethylene vinyl acetate wax or hard waxes in accordance with Fischer-Tropsch processes;
halogenated hydrocarbons, such as chloroparaffin, bromooctadecane, bromopentadecane, bromononadecane, bromoeicosane, bromodocosane.

Mixtures of these substances are also suitable provided the melting point is not lowered outside of the desired range, or the heat of fusion of the mixture becomes too low for a useful application.

For example, the use of pure n-alkanes, n-alkanes with a purity greater than 80% or of alkane mixtures as are produced as technical-grade distillate and are commercially available as such is advantageous.

Furthermore, it may be advantageous to add the lipophilic substances in their soluble compounds in order to prevent the crystallization delay which sometimes occurs with nonpolar substances. It is advantageous to use, as described in U.S. Pat. No. 5,456,852, compounds with a melting point 20 to 120 K higher than the actual core substance. Suitable compounds are the fatty acids, fatty alcohols, fatty amides and also aliphatic hydrocarbon compounds mentioned above as lipophilic substances. They are added in amounts of from 0.1 to 10% by weight, based on the capsule core.

The latent heat storage materials are selected depending on the temperature range in which the heat storage media are desired. For example, for heat storage media in construction materials in a moderate climate, preference is given to using latent heat storage materials whose solid/liquid phase transition is in the temperature range from 0 to 60° C. Thus, for interior applications, individual materials or mixtures with conversion temperatures of from 15 to 30° C. are usually selected.

Preferred latent heat storage materials are aliphatic hydrocarbons, particularly preferably those listed above by way of example. In particular, aliphatic hydrocarbons having 14 to 20 carbon atoms, and mixtures thereof are preferred.

The microcapsules can be processed directly as aqueous microcapsule dispersion or in the form of a powder, which can be obtained by spray-drying the microcapsule dispersion.

The spray-drying of the microcapsule dispersion can be carried out in a customary manner. In general, the procedure is carried out such that the inlet temperature of the stream of warm air is in the range from 100 to 200° C., preferably 120 to 160° C., and the exit temperature of the stream of warm air is in the range from 30 to 90° C., preferably 60 to 80° C. The spraying of the aqueous polymer dispersion in the stream of warm air can take place, for example, by means of single- or multi-material nozzles or via a rotating disc. The polymer powder is normally deposited using cyclones or filter separators. The sprayed aqueous polymer dispersion and the stream of warm air are preferably conveyed in parallel.

For the spray-drying, spray auxiliaries are optionally added in order to facilitate the spray-drying, or to establish certain powder properties, e.g. freedom from dust, flowability or improved redispersibility. The person skilled in the art is familiar with a large number of spray auxiliaries. Examples thereof can be found in DE-A 19629525, DE-A 19629526, DE-A 2214410, DE-A 2445813, EP-A 407889 or EP-A 784449. Advantageous spray auxiliaries are, for example, water-soluble polymers of the polyvinyl alcohol type or partially hydrolyzed polyvinyl acetates, cellulose derivatives, such as hydroxyethylcellulose, carboxymethylcellulose, methylcellulose, methylhydroxyethylcellulose and methylhydroxypropylcellulose, starch and starch derivatives, oligosaccharides, sugars and sugar derivatives, such as maltodextrin, polyvinylpyrrolidone, copolymers of vinylpyrrolidone, gelatin, preferably polyvinyl alcohol and partially hydrolyzed polyvinyl acetates, and methylhydroxypropylcellulose.

According to the invention, the gypsum core further comprises a polymer P, which has a glass transition temperature T_{g} in the range from −60 to 160° C. Here, the polymer P can be used according to one embodiment in aqueous solution or according to a further embodiment in the form of an aqueous dispersion. In this connection, it is possible to use a polymer P and also mixtures of two or more polymers P.

Aqueous dispersions of the polymers P as polymeric binders are generally known. These are fluid systems which comprise, as disperse phase in an aqueous dispersion medium, polymer tangles consisting of two or more intertwined polymer chains, the so-called polymer matrix or polymer particles, present in disperse distribution. The weight-average diameter of the polymer particles is often in the range from 10 to 1000 nm, often 50 to 500 nm or 100 to 400 nm.

According to the invention, it is possible to use those polymers P whose glass transition temperature is −60 to +160° C., generally −60 to +100° C., often −20 to +100° C. and often 0 to +100° C. Glass transition temperature (T_{g}) means the limit of the glass transition temperature to which, according to G. Kanig (Kolloid-Zeitschrift & Zeitschrift für Polymere, Vol. 190, page 1, equation 1), the glass transition temperature tends with increasing molecular weight. The glass transition temperature is determined by the DSC method (Differential Scanning calorimetry, 20 K/min, midpoint measurement, DIN 53 765).

In this connection, it is possible for the person skilled in the art to produce, through targeted selection of the monomer composition, polymers with a glass transition temperature in the range from −60 to +160° C.

According to Fox (see Ullmanns Enzyklopädie der technischen Chemie [Ullmanns Encyclopedia of Industrial Chemistry], 4^{th} edition, Volume 19, Weinheim (1980), pp. 17, 18), the glass transition temperature T_{g} can be estimated. The following applies for the glass transition temperature of weakly or uncrosslinked mixed polymers with large molar masses in good approximation:

$$\frac{1}{Tg} = \frac{{X}^{1}}{{Tg}^{1}} + \frac{{X}^{2}}{{Tg}^{2}} + … \frac{{X}^{n}}{{Tg}^{n}}$$

where X¹, X², . . . , Xn are the mass fractions 1, 2, . . . , n and T_{g}¹, T_{g}², . . . , T_{g}ⁿ are the glass transition temperatures of the polymers formed in each case only from one of the monomers 1, 2, . . . , n, in degrees Kelvin. The latter are known, for example, from Ullmann's Encyclopedia of Industrial Chemistry, VCH, 5th ed. Weinheim, Vol. A 21 (1992) p. 169 or from J. Brandrup, E. H. Immergut, Polymer Handbook 3^{rd} ed, J. Wiley, New York 1989.

Preference is given to polymers P with a glass transition temperature in the range from −60 to 100° C. which are formed by free-radical emulsion polymerization of at least one ethylenically unsaturated monomer.

Preferred polymers P are formed from ethylenically unsaturated monomers M which generally comprise at least 80% by weight, in particular at least 90% by weight, of ethylenically unsaturated monomers A with a solubility in water of <30 g/I (25° C. and 1 bar), where up to 30% by weight, e.g. 5 to 25% by weight, of the monomers A can be replaced by acrylonitrile and/or methacrylonitrile. In addition, the polymers also comprise 0.5 to 20% by weight of monomers B different from the monomers A. Here and below, all of the quantitative data for monomers are in % by weight, based on 100% by weight of monomers M.

Monomers A are generally monoethylenically unsaturated or conjugated diolefins. Examples of monomers A are:
esters of an α,β-ethylenically unsaturated C₃-C₆-monocarboxylic acid or C₄-C₈-dicarboxylic acid with a C₁-C₁₀-alkanol. These are preferably esters of acrylic acid or methacrylic acid, such as methyl(meth)acrylate, ethyl(meth)acrylate, n-butyl(meth)acrylate, t-butyl(meth)acrylate, 2-ethylhexyl(meth)acrylate etc.;
vinyl aromatic compounds, such as styrene, 4-chlorostyrene, 2-methylstyrene etc.,
vinyl esters of aliphatic carboxylic acids having preferably 1 to 10 carbon atoms, such as vinyl acetate, vinyl propionate, vinyl laurate, vinyl stearate, vinyl versatate etc.;
olefins, such as ethylene or propylene;
conjugated diolefins, such as butadiene or isoprene;
vinyl chloride or vinylidene chloride;
maleic anhydride.

Preferred polymers P are selected from the polymer classes I to VI listed below:
I) copolymers of styrene with alkyl (acrylates), i.e. copolymers which comprise, in copolymerized form, as monomer A, styrene and at least one C₁-C₁₀-alkyl ester of acrylic acid and optionally one or more C₁-C₁₀-alkyl esters of methacrylic acid;
II) copolymers of styrene with butadiene, i.e. copolymers which comprise, in copolymerized form, as monomer A, styrene and butadiene, and optionally (meth)acrylates of C₁-C₈-alkanols, acrylonitrile and/or methacrylonitrile;
III) homopolymers and copolymers of alkyl(meth)acrylates (straight acrylates), i.e. homopolymers and copolymers which comprise, in copolymerized form, as monomers A, at least one C₁-C₁₀-alkyl ester of acrylic acid and/or a C₁-C₁₀-alkyl ester of methacrylic acid, in particular copolymers which comprise, in copolymerized form, as monomers A, methyl methacrylate, at least one C₁-C₁₀-alkyl ester of acrylic acid and optionally a C₂-C₁₀-alkyl ester of methacrylic acid;
IV) homopolymers of vinyl esters of aliphatic carboxylic acids and copolymers of vinyl esters of aliphatic carboxylic acids with olefins and/or alkyl(meth)acrylates, i.e. homopolymers and copolymers which comprise, in copolymerized form, as monomer A, at least one vinyl ester of an aliphatic carboxylic acid with 2 to 10 carbon atoms and optionally one or more C₂-C₆-olefins and/or optionally one or more C₁-C₁₀-alkyl esters of acrylic acid and/or of methacrylic acid;
V) copolymers of styrene with acrylonitrile
VI) copolymers of olefins with maleic anhydride.

Typical C₁-C₁₀-alkyl esters of acrylic acid in the copolymers of class I to IV are ethyl acrylate, n-butyl acrylate, tert-butyl acrylate, n-hexyl acrylate and 2-ethylhexyl acrylate.

Typical copolymers of class I comprise, as monomers A, 20 to 80% by weight and in particular 30 to 70% by weight, of styrene and 20 to 80% by weight, in particular 30 to 70% by weight, of at least one C₁-C₁₀-alkyl ester of acrylic acid, such as n-butyl acrylate, ethyl acrylate or 2-ethylhexyl acrylate, in each case based on the total amount of the monomers A.

Typical copolymers of class II comprise, as monomers A, in each case based on the total amount of the monomers A, 30 to 85% by weight, preferably 40 to 80% by weight and particularly preferably 50 to 75% by weight, of styrene and 15 to 70% by weight, preferably 20 to 60% by weight and particularly preferably 25 to 50% by weight, of butadiene, where 5 to 20% by weight of the aforementioned monomers A can be replaced by (meth)acrylic esters of C₁-C₈-alkanols and/or by acrylonitrile or methacrylonitrile.

Typical copolymers of class III comprise, in copolymerized form, as monomers A, in each case based on the total amount of the monomers A, 20 to 80% by weight, preferably 30 to 70% by weight, of methyl methacrylate and at least one, preferably one or two, further monomers selected from acrylic acid esters of C₁-C₁₀-alkanols, in particular n-butyl acrylate, 2-ethylhexyl acrylate and ethyl acrylate and optionally a methacrylic acid ester of a C₂-C₁₀-alkanol in a total amount of from 20 to 80% by weight and preferably 30 to 70% by weight.

Typical homopolymers and copolymers of class IV comprise, in copolymerized form, as monomers A, in each case based on the total amount of the monomers A, 30 to 100% by weight, preferably 40 to 100% by weight and particularly preferably 50 to 100% by weight, of a vinyl ester of an aliphatic carboxylic acid, in particular vinyl acetate, and 0 to 70% by weight, preferably 0 to 60% by weight and particularly preferably 0 to 50% by weight, of a C₂-C₆-olefin, in particular ethylene, and optionally one or two further monomers selected from (meth)acrylic acid esters of C₁-C₁₀-alkanols in an amount of from 1 to 15% by weight.

Among the aforementioned polymers, the polymers of classes IV, V and VI are particularly suitable.

Preference is given to homopolymers of vinyl esters of aliphatic carboxylic acids, in particular of vinyl acetate. A specific embodiment is those which are stabilized with protective colloids such as polyvinylpyrrolidone and anionic emulsifiers. One such embodiment is described in WO 02/26845, to which reference is expressly made.

Suitable monomers B are in principle all monomers which are different from the aforementioned monomers and are copolymerizable with the monomers A. Monomers of this type are known to the person skilled in the art and generally serve for modifying the properties of the polymer.

Preferred monomers B are selected from monoethylenically unsaturated mono- and dicarboxylic acids having 3 to 8 carbon atoms, in particular acrylic acid, methacrylic acid, itaconic acid, amides thereof, such as acrylamide and methacrylamide, N-alkylolamides thereof, such as N-methylolacrylamide and N-methylolmethacrylamide, hydroxy-C₁-C₄-alkyl esters thereof, such as 2-hydroxyethyl acrylate, 2- and 3-hydroxypropyl acrylate, 4-hydroxybutyl acrylate, 2-hydroxyethyl methacrylate, 2- and 3-hydroxypropyl methacrylate, 4-hydroxybutyl methacrylate and monoethylenically unsaturated monomers with oligoalkylene oxide chains, preferably with polyethylene oxide chains with degrees of oligomerization preferably in the range from 2 to 200, e.g. monovinyl and monoallyl ethers of oligoethylene glycols, and also esters of acrylic acid, of maleic acid or of methacrylic acid with oligoethylene glycols.

The fraction of monomers with acid groups is preferably not more than 10% by weight and in particular not more than 5% by weight, e.g. 0.1 to 5% by weight, based on the monomers M. The fraction of hydroxyalkyl esters and monomers with oligoalkylene oxide chains is, if present, preferably in the range from 0.1 to 20% by weight and in particular in the range from 1 to 10% by weight, based on the monomers M. The fraction of amides and N-alkylolamides is, if present, preferably in the range from 0.1 to 5% by weight.

Besides the aforementioned monomers B, suitable further monomers B are also crosslinking monomers, such as glycidyl ethers and esters, e.g. vinyl, allyl and methallyl glycidyl ethers, glycidyl acrylate and methacrylate, the diacetonylamides of the aforementioned ethylenically unsaturated carboxylic acids, e.g. diacetone (meth)acrylamide, and the esters of acetylacetic acid with the aforementioned hydroxyalkyl esters of ethylenically unsaturated carboxylic acids, e.g. acetylacetoxyethyl(meth)acrylate. Suitable monomers B are also compounds which have two nonconjugated, ethylenically unsaturated bonds, e.g. the di- and oligoesters of polyhydric alcohols with α,β-monoethylenically unsaturated C₃-C₁₀-monocarboxylic acids, such as alkylene glycol diacrylates and dimethacrylates, e.g. ethylene glycol diacrylate, 1,3-butylene glycol diacrylate, 1,4-butylene glycol diacrylate, propylene glycol diacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, tricyclodecenyl(meth)acrylate, N,N′-divinylimidazolin-2-one or triallyl cyanurate. The fraction of crosslinking monomers is generally not more than 1% by weight, based on the total amount of monomers, and will in particular not exceed 0.1% by weight.

Further suitable monomers B are also vinylsilanes, e.g. vinyltrialkoxysilanes. These are, if desired, used in an amount of from 0.01 to 1% by weight, based on the total amount of the monomers, in the preparation of the polymers.

Aqueous polymer dispersions are accessible in particular by free-radically initiated aqueous emulsion polymerization of ethylenically unsaturated monomers. This method has already been described widely and is thus sufficiently known to the person skilled in the art [cf. e.g. Encyclopedia of Polymer Science and Engineering, Vol. 8, pages 659 to 677, John Wiley & Sons Inc., 1987; D. C. Blackley, Emulsion Polymerisation, pages 155 to 465, Applied Science Publishers Ltd., Essex, 1975; D. C. Blackley, Polymer Latices, 2nd Edition, Vol. 1, pages 33 to 415, Chapman & Hall, 1997; H. Warson, The Applications of Synthetic Resin Emulsions, pages 49 to 244, Ernest Benn Ltd., London, 1972; D. Diederich, Chemie in unserer Zeit 1990, 24, pages 135 to 142, Verlag Chemie, Weinheim; J. Piirma, Emulsion Polymerisation, pages 1 to 287, Academic Press, 1982; F. Hölscher, Dispersionen synthetischer Hochpolymerer [Dispersions of Synthetic High Polymers], pages 1 to 160, Springer-Verlag, Berlin, 1969 and the patent specification DE-A 40 03 422]. The free-radically initiated aqueous emulsion polymerization usually takes place by dispersedly distributing the ethylenically unsaturated monomers, frequently with co-use of surface-active substances, in aqueous medium and polymerizing them using at least one free-radical polymerization initiator. Often, with the resulting aqueous polymer dispersions, the residual contents of unreacted monomers are reduced by chemical and/or physical methods likewise known to the person skilled in the art [see, for example, EP-A 771328, DE-A 19624299, DE-A 19621027, DE-A 19741184, DE-A 19741187, DE-A 19805122, DE-A 19828183, DE-A 19839199, DE-A 19840586 and 19847115], the polymer solids content is adjusted to a desired value by dilution or concentration, or further customary additives, such as, for example, bactericidal or foam-suppressing additives, are added to the aqueous polymer dispersion. The polymer solids contents of the aqueous polymer dispersions are often 30 to 80% by weight, 40 to 70% by weight or 45 to 65% by weight. The polymer powders prepared from the polymer dispersions are likewise preferred, as are aqueous dispersions obtainable by redispersing the polymer powders in water.

Both aqueous polymer dispersions and also the powders produced therefrom are, moreover, commercially available, e.g. under the brands ACRONAL®, STYRONAL®, BUTOFAN®, STYROFAN® and KOLLICOAT® from BASF-Aktiengesellschaft, Ludwigshafen, Germany, VINNOFIL® and VINNAPAS® from Wacker Chemie-GmbH, Burghausen, and RHODIMAX® from Rhodia S.A.

Suitable surface-active substances for the emulsion polymerization are the emulsifiers and protective colloids customarily used for emulsion polymerization. Preferred emulsifiers are anionic and nonionic emulsifiers which, in contrast to the protective colloids, generally have a molecular weight below 2000 g/mol and are used in amounts of up to 0.2 to 10% by weight, preferably 0.5 to 5% by weight, based on the polymer in the dispersion or on the monomers M to be polymerized.

Protective colloids of this type have already been specified above by way of example for the microcapsule formation.

The anionic emulsifiers include alkali metal and ammonium salts of alkyl sulfates (alkyl radical: C₈-C₂₀), of sulfuric acid half-esters of ethoxylated alkanols (degree of EO: 2 to 50, alkyl radical: C₈ to C₂₀) and ethoxylated alkylphenols (degree of EO: 3 to 50, alkyl radical: C₄-C₂₀)), of alkylsulfonic acids (alkyl radical: C₈ to C₂₀), of sulfonated mono- and di-C₆-C₁₈-alkyl diphenyl ethers, as described in U.S. Pat. No. 4,269,749, and of alkylarylsulfonic acids (alkyl radical: C₄-C₂₀). Further suitable anionic emulsifiers can be found in Houben-Weyl, Methoden der organischen Chemie [Methods of organic chemistry], Volume XIV/1, Makromolekulare Stoffe [Macromolecular substances], Georg-Thieme-Verlag, Stuttgart, 1961, pp. 192-208.

Suitable nonionic emulsifiers are araliphatic or aliphatic nonionic emulsifiers, for example ethoxylated mono-, di- and trialkylphenols (degree of EO: 3 to 50, alkyl radical: C₄-C₉), ethoxylates of long-chain alcohols (degree of EO: 3 to 50, alkyl radical: C₈-C₃₆), and also polyethylene oxide/polypropylene oxide block copolymers. Preference is given to ethoxylates of long-chain alkanols (alkyl radical: C₁₀-C₂₂, average degree of ethoxylation: 3 to 50) and, of these, particular preference is given to those based on oxo alcohols and native alcohols with a linear or branched C₁₂-C₁₈-alkyl radical and a degree of ethoxylation of from 8 to 50.

The molecular weight of the polymers can of course be adjusted by adding regulators in a small amount, generally up to 2% by weight, based on the polymerizing monomers M. Suitable regulators are, in particular, organic thio compounds, and also allyl alcohols and aldehydes. In the preparation of the butadiene-comprising polymers of class I, regulators are often used in an amount of from 0.1 to 2% by weight, preferably organic thio compounds, such as tert-dodecyl mercaptan.

When the polymerization is complete, the polymer dispersions used are often rendered alkaline, preferably to a pH in the range from 7 to 10, prior to their use according to the invention. For the neutralization it is possible to use ammonia or organic amines, and also preferably hydroxides, such as sodium hydroxide, potassium hydroxide or calcium hydroxide.

To prepare polymer powders P, the aqueous polymer dispersions are subjected in a known manner to a drying process, preferably in the presence of customary drying auxiliaries. A preferred drying process is spray-drying. If required, the drying auxiliary is used in an amount of from 1 to 30% by weight, preferably 2 to 20% by weight, based on the polymer content of the dispersion to be dried.

The spray-drying of the polymer dispersions to be dried generally takes place as already described for the microcapsule dispersion, often in the presence of a customary drying auxiliary such as homo- and copolymers of vinylpyrrolidone, homo- and copolymers of acrylic acid and/or of methacrylic acid with monomers carrying hydroxyl groups, vinylaromatic monomers, olefins and/or (meth)acrylic acid esters, polyvinyl alcohol and in particular arylsulfonic acid-formaldehyde condensation products, and mixtures thereof.

In addition, a customary anticaking agent (antibaking agent), such as a finely divided inorganic oxide, for example a finely divided silica or a finely divided silicate, e.g. talc, can be added to the polymer dispersion to be dried during the drying operation.

According to a further preferred embodiment, suitable polymers P are those which are water-soluble or partially water-soluble and have a glass transition temperature in the range from 0 to 160° C. Partially water-soluble is to be understood here as meaning a solubility of >10 g/I (25° C. and 1 bar). Natural polymeric binders, such as starch, starch derivatives and cellulose, and also synthetic polymeric binders are suitable. Binders of this type are, for example, polyvinylpyrrolidone, polyvinyl alcohol or partially hydrolyzed polyvinyl acetate with a degree of hydrolysis of at least 60%, and also copolymers of vinyl acetate with vinylpyrrolidone, also graft polymers of polyvinyl acetate with polyethers, in particular ethylene oxide. Graft polymers of polyvinyl acetate with ethylene oxide have proven to be particularly advantageous. Such graft polymers are described, for example, in EP-A-1 124 541, to the teaching of which reference is expressly made.

Polymers of this type are, moreover, commercially available, e.g. under the brands KOLLIDON® and KOLLICOAT® and LUVISKOL® from BASF SE.

As is generally known, the gypsum slurry is prepared by continually adding and constantly mixing β-hemihydratecalcium sulfate in water with additives. The microcapsules can be processed either as dispersion, preferably as powder, with the other substances to give the gypsum slurry. The polymer P can likewise be processed either as powder, or as dispersion or aqueous solution with the other substances to give the gypsum slurry.

Preferably, the microcapsules and the polymer are mixed beforehand and used as aqueous mixture to produce the gypsum construction board. Here, according to one embodiment, it is possible to mix the microcapsule powder with an aqueous solution or dispersion of the polymer P before it is mixed with the gypsum slurry. According to a further embodiment, it is possible to mix the aqueous microcapsule dispersion and the polymer P in the form of a powder before the mixture is mixed with the gypsum slurry.

According to one preferred embodiment, the aqueous microcapsule dispersion is mixed with an aqueous dispersion of the polymer P or of an aqueous solution beforehand and is then mixed with the gypsum slurry.

The aqueous mixture of polymer P and microcapsules is preferably spray-dried and the spray-dried polymer-modified microcapsule powder is used for producing the gypsum construction board. The spray-drying takes place here as described above for the microcapsules. Spray-dried microcapsules obtained in this way have improved tightness. It is assumed that the polymer P forms a film and thus forms an additional polymer layer around the capsule which partly or completely covers the wall. Microcapsules which are obtained by spray-drying a mixture of aqueous polymer dispersion of a polymer P which has a glass transition temperature T_{g} in the range from −60 to 100° C. and microcapsules are novel.

The present invention therefore also provides microcapsule powders, preferably with an average particle size of from 20 to 500 μm, obtainable by spray-drying an aqueous mixture comprising microcapsules with a lipophilic capsule core and a capsule wall formed from
30 to 100% by weight, based on the total weight of the monomers, of one or more monomers (monomers I) selected from C₁-C₂₄-alkyl esters of acrylic and methacrylic acid, acrylic acid, methacrylic acid and maleic acid,
0 to 70% by weight, based on the total weight of the monomers, of one or more monomers with at least two nonconjugated ethylenic double bonds (monomers II), which is insoluble or sparingly soluble in water, and
0 to 40% by weight, based on the total weight of the monomers, of one or more other monomers (monomers III),
   and a polymer P, which has a glass transition temperature T_{g} in the range from −60 to 100° C.

Preference is given to polymers P with a glass transition temperature in the range from −60 to 100° C. which are formed by free-radical emulsion polymerization of at least one ethylenically unsaturated monomer.

Preferred polymers P are formed from ethylenically unsaturated monomers M, which generally comprise at least 80% by weight, in particular at least 90% by weight, of ethylenically unsaturated monomers A, with a solubility in water of <30 g/I (25° C. and 1 bar), preferably those mentioned above, where up to 30% by weight, e.g. 5 to 25% by weight, of the monomers A can be replaced by acrylonitrile and/or methacrylonitrile. In addition, the polymers also comprise 0.5 to 20% by weight of monomers B different from the monomers A, in particular those mentioned above.

Preferred polymers P are selected from the polymer classes I to VI listed above, in particular the polymer classes IV, V and VI.

Furthermore, the present invention provides a method for producing these microcapsules by spray-drying an aqueous mixture comprising microcapsules and an aqueous dispersion of the polymer P.

The fraction of polymer P (solid) is usually 1-30 parts by weight, preferably 2-20 parts by weight, in particular 5-15 parts by weight, in each case based on 100 parts by weight of microcapsules (likewise calculated as solid). The dilution of the mixture intended for spray-drying is largely arbitrary. However, it is advantageous to use an aqueous mixture with a total solids content of from 15 to 45%.

The microcapsules are used in amounts of from 5 to 50% by weight, based on gypsum.

The gypsum construction board according to the invention comprises two covering layers and one gypsum core.

Advantageous covering layers are cardboard sheets based on cellulose and also woven or nonwovens. Materials for nonwovens of this type are glass fibers, polymer fibers made of e.g. polypropylene, polyester, polyamide, polyacrylates, polyacrylonitrile and the like. Particular preference is given to using glass fiber nonwoven as covering layers. Construction boards of this type are known, for example, from U.S. Pat. No. 4,810,569, U.S. Pat. No. 4,195,110, U.S. Pat. No. 4,394,411, EP 755903, EP 503383 and EP 427063. Preference is given to gypsum construction boards with a dual-sided covering layer made of glass fiber nonwoven.

In this connection, preferably 5 to 40% by weight, in particular 20 to 35% by weight, of microcapsule powders, based on the total weight of the construction board, in particular gypsum construction board, (dry substance) are incorporated. The production of gypsum construction boards with microencapsulated latent heat storage materials is generally known and described in EP-A 1 421 243, to which reference is expressly made. They are usually produced by applying aqueous gypsum slurry discontinuously or, preferably, continuously between two covering layers to form boards. The gypsum slurry is prepared by continuously adding and constantly mixing p-hemihydrate calcium sulfate in water with additives. The microcapsules can be metered in together with the calcium sulfate, or already be present as an aqueous dispersion.

Additives which can be used are generally up to 2% by weight, based on the mineral constituents, of liquefiers, retarders and/or accelerators known to the person skilled in the art.

The gypsum slurry obtained in this way is applied to, for example sprayed on, the covering layer and covered with the second covering layer. As hardening starts, the construction boards are shaped in a press to give strips with, for example, a width of 1.2-1.25 m and a thickness of 9.25, 12.5, 15.0, 18.0 or 25 mm. These strips harden within a few minutes and are cut into boards. At this stage, the boards still generally comprise a third of their weight as free water. In order to remove the remaining water, the boards are subjected to a heat treatment at temperatures up to 250° C. For this purpose, tunnel dryers, for example, are used.

The gypsum construction boards obtained in this way have a density of 750-950 kg/m³.

Even over a prolonged period, the gypsum construction boards according to the invention have good tightnesses, even at relatively low temperatures.

The examples below are intended to illustrate the invention. The percentage data in the examples are percent by weight, unless stated otherwise.

The particle size of the microcapsule dispersion was determined using a Malvern Particle Sizer model 3600E in accordance with a standard measuring method documented in the literature. The D[v, 0.1] value implies that 10% of the particles have a particle size (according to the volume-average) up to this value. Accordingly, D[v, 0.5] means that 50% of the particles have a particle size (according to the volume-average) of less than/equal to this value, and D[v, 0.9] means that 90% of the particles have a particle size (according to the volume-average) less than/equal to this value. The span value arises from the quotient of the difference D[v, 0.9] −D[v, 0.1]) and D[v, 0.5].

Preparation of the Microcapsule Dispersion

### EXAMPLE 1

Water Phase:
680 g of water
110 g of a 50% strength by weight silica sol (specific surface area ca. 80 m²/g)
8 g of a 5% strength by weight aqueous solution of methylhydroxypropyl-cellulose with an average molecular weight of 26 000 g/mol
2.1 g of a 2.5% strength by weight aqueous sodium nitrite solution
4.0 g of a 20% strength by weight nitric acid solution in water

Oil Phase
308.0 g of a mixture of substantially linear paraffins with a melting point of ca. 26° C.
123.2 g of hexadecane (technical-grade)
8.8 g of a technical-grade paraffin with a melting point of ca. 65° C.
66.0 g of methyl methacrylate
44.0 g of pentaerythritol tetraacrylate (technical-grade, Cytec)

Addition 1
0.92 g of a 75% strength solution of t-butyl perpivalate in aliphatic hydrocarbons

Feed 1:
22.0 g of a 5% strength by weight aqueous Na peroxodisulfate solution
30.0 g of water

The water phase was initially introduced at 40° C.; to this was added the melted and homogeneously mixed oil phase, and the mixture was dispersed for 40 minutes in a high-speed dissolver stirrer (disc diameter 5 cm) at 3500 rpm. Addition 1 was added. The emulsion was heated with stirring using an anchor stirrer to 70° C. within 60 minutes, and to 90° C. over the course of a further 60 minutes and held at 90° C. for 60 minutes. Feed 1 was metered into the resulting microcapsule dispersion with stirring over 90 minutes at 90° C. and then the mixture was stirred at this temperature for 2 hours. The mixture was then cooled to room temperature and neutralized with aqueous sodium hydroxide solution.

This gave a microcapsule dispersion with an average particle size of 7.2 μm and a solids content of 43.6%.

General Description of the Experiments

In each case 100 g of the microcapsule dispersion obtained from Example 1 were mixed with the polymer solutions or polymer dispersions specified in Examples A-F below. In order to test the tightness of the resulting microcapsule polymer mixtures, in each case ca. 2 g of the resulting mixture were dried for two hours at 105° C. in order to remove any residual water. The weight (m₀) was then determined. After heating for one hour at 180° C. and cooling, the weight (m₁) was determined. The weight difference (m₀−m₁) based on m₀ and multiplied by 100 gives the evaporation rate in %. The lower the value, the tighter the microcapsules.

### EXAMPLE A

### Comparative Example—Not According to the Invention, without Polymer

The evaporation rate of the microcapsule dispersion obtained from Example 1 is 67.3%.

### EXAMPLE B

16.8 g of a Mowiol®-18-88 solution (10% strength by weight in water) were mixed with 100 g of microcapsule dispersion of Example 1 in accordance with the general procedure.

The evaporation rate of the microcapsule/polymer sample was determined.

The evaporation rate at 180° C. was 17.9%.

### EXAMPLE C

3.4 g of starch solution (50% strength by weight in water) were mixed with 100 g of microcapsule dispersion of Example 1 in accordance with the general procedure.

The evaporation rate of the microcapsule/polymer sample was determined.

The evaporation rate at 180° C. was 54.2%.

### EXAMPLE D

6.5 g of a 26% strength by weight aqueous dispersion of an olefin/maleic anhydride copolymer were mixed with 100 g of microcapsule dispersion of Example 1 in accordance with the general procedure.

The evaporation rate of the microcapsule/polymer sample was determined.

The evaporation rate at 180° C. was 43.1%.

### EXAMPLE E

2.55 g of starch solution (50% strength by weight) and 1.6 g of an aqueous dispersion of an olefin/maleic anhydride copolymer (26% strength by weight in water) were mixed with 100 g of microcapsule dispersion of Example 1 in accordance with the general procedure.

The evaporation rate of the microcapsule/polymer sample was determined.

The evaporation rate at 180° C. was 18.3%.

### EXAMPLE F

16.8 g of a Mowiol-40-88 solution (10% strength by weight) were mixed with 100 g of microcapsule dispersion of Example 1 in accordance with the general procedure.

The evaporation rate of the microcapsule/polymer sample was determined.

The evaporation rate at 180° C. was 14.5%.

In the case of the aforementioned examples, on account of the procedure for sample preparation for determining the evaporation rate, it cannot be excluded that the capsules after drying are covered by a macroscopic film of the polymer. In order to investigate the tightness of the individual capsules, a second determination of the evaporation rate was also carried out:

In each case 100 g of the microcapsule dispersion obtained from Example 1 were mixed with the polymer solutions or polymer dispersions specified in Examples G-J below. In order to test the tightness of the resulting microcapsule polymer mixtures, the mixture obtained in each case was diluted to a total solids content of 20% and ca. 0.5 g of this mixture was dripped onto ca. 2 g of sand. The evaporation rate of the sample prepared in this way was determined at 180° C. Application to the sand is intended to increase the surface area and separate out individual capsules, meaning that the measurement result is not influenced by agglomerate formation and film formation as a layer over the capsules.

Determination of the evaporation rate at 180° C.

For the pretreatment, 2 g of the sand/microcapsule/polymer sample were dried in a small metal dish for two hours at 105° C. in order to remove any residual water. The weight (m₀) was then determined. After heating for one hour at 180° C. and cooling, the weight (m₁) was determined. The weight difference (m₀−m₁) based on m₀ and multiplied by 100 gives the evaporation rate in %. The lower the value, the tighter the microcapsules.

### EXAMPLE G

### Not According to the Invention

100 g of the microcapsule dispersion prepared according to Example 1 were treated in accordance with the general procedure without adding polymer.

The evaporation rate of the sand/microcapsule sample was determined.

The evaporation rate at 180° C. was 41%.

### EXAMPLE H

17.4 g of Luviskol® K90 solution (polyvinylpyrrolidone, K value 90, 10% strength by weight polymer solution in water, manufacturer BASF SE) were mixed with 100 g of microcapsule dispersion of Example 1 in accordance with the general procedure.

The evaporation rate of the sand/microcapsule/polymer sample was determined.

The evaporation rate at 180° C. was 27.4%.

### EXAMPLE I

5 g of Acronal® 290 D dispersion (50% by weight solids, manufacturer BASF SE) were mixed with 100 g of microcapsule dispersion of Example 1 in accordance with the general procedure.

The evaporation rate of the sand/microcapsule/polymer sample was determined.

The evaporation rate at 180° C. was 32.2%.

### EXAMPLE J

4 g of Luviskol VA 64 solution (50% strength by weight polymer solution in water) were mixed with 100 g of microcapsule dispersion of Example 1 in accordance with the general procedure.

The evaporation rate of the sand/microcapsule/polymer sample was determined.

The evaporation rate at 180° C. was 34.4%.

The aqueous mixtures of polymer/microcapsules prepared according to Examples B to F and H to J can be incorporated into gypsum slurry in customary amounts, for example in the mixing ratio of 1:9 to 5:5 solids to gypsum hemihydrate and processed on a conveyor belt to give boards.

### EXAMPLE K

1000 g of the microcapsule dispersion described in Example 1 were admixed with 168 g of a Mowiol®-18-88 solution (10% strength by weight in water) and spray-dried to give a powder whose average particle size was between 50 and 250 μm. The powder obtained was stirred into a gypsum slurry in the ratio 30:70 capsule powder to gypsum hemihydrate. A gypsum board was produced from this gypsum mixture by drying in a furnace.

Air analysis with the help of a suction belt revealed a paraffin loading of the air which was a factor of 4 below a comparison board which had been produced with the help of a microcapsule powder which had been prepared by spray-drying a capsule dispersion from Example 1, but without the prior addition of further polymers to the dispersion.

1. A gypsum construction board, comprising two covering layers and a gypsum core, comprising microcapsules, wherein:
the microcapsules comprise a lipophilic capsule core and a capsule wall,
the capsule wall comprises a polymer P and, in polymerized form
(I) 30 to 100% by weight, based on a total weight of monomers, of at least one monomer (I) selected from the group consisting of a C₁-C₂₄-alkyl ester of acrylic and methacrylic acid, acrylic acid, methacrylic acid and maleic acid,
(II) 0 to 70% by weight, based on the total weight of monomers, of a monomer (II) comprising at least two nonconjugated ethylenic double bonds, which is insoluble or sparingly soluble in water, and
(III) 0 to 40% by weight, based on the total weight of monomers, of a monomer (III); and
the polymer P has a glass transition temperature T_{g} in the range from −60 to 160° C.

2. The gypsum construction board of claim 1, wherein the capsule wall comprises, in polymerized form
50 to 90% by weight, based on the total weight of monomers, of the at least one monomer (I)
10 to 50% by weight, based on the total weight of monomers, of the monomer (II), and
0 to 30% by weight, based on the total weight of monomers, of the monomer (III).

3. The gypsum construction board of claim 1, wherein the polymer P has a glass transition temperature in the range from −60 to 100 and is formed from one or more ethylenically unsaturated monomers M by emulsion polymerization.

4. The gypsum construction board of claim 1, wherein the polymer P comprises a homopolymer of at least one vinyl ester of an aliphatic carboxylic acid and a copolymer of at least one vinyl ester of an aliphatic carboxylic acid with at least one olefin, alkyl(meth)acrylate, or both.

5. The gypsum construction board of claim 1, wherein the polymer P comprises a copolymer of styrene with acrylonitrile.

6. The gypsum construction board of claim 1, wherein the polymer P is water-soluble or partially water-soluble and has a glass transition temperature in the range from 0 to 160° C.

7. The gypsum construction board of claim 1, comprising an aqueous mixture of the microcapsules and the polymer P.

8. The gypsum construction board of claim 1, wherein the gypsum is formed from a microcapsule powder which is obtained by spray-drying an aqueous mixture of the microcapsules and the polymer P.

9. The gypsum construction board of claim 1, wherein the covering layers comprise cardboard sheets comprising woven or nonwoven cellulose.

10. The gypsum construction board of claim 1, comprising 1 to 30 parts by weight of the polymer P based on 100 parts by weight of the microcapsules.

11. A method for producing the gypsum construction board of claim 1, the method comprising:
applying a gypsum slurry comprising the microcapsules and the polymer P to a covering layer;
covering with a second covering layer;
after setting, cutting and drying a resulting board; and
optionally drying the resulting board.

12. A microcapsule powder obtained by spray-drying an aqueous mixture comprising microcapsules comprising a lipophilic capsule core and a capsule wall
wherein:
the capsule wall comprises a polymer P and, in polymerized form
(I) 30 to 100% by weight, based on a total weight of monomers, of at least one monomer (I) selected from the group consisting of a C₁-C₂₄-alkyl ester of acrylic and methacrylic acid, acrylic acid, methacrylic acid and maleic acid,
(II) 0 to 70% by weight, based on the total weight of monomers, of a monomer (II) comprising at least two nonconjugated ethylenic double bonds, which is insoluble or sparingly soluble in water, and
(III) 0 to 40% by weight, based on the total weight of monomers, of a monomer (III); and
the polymer P, which has a glass transition temperature T_{g} in the range from −60 to 100° C.

13. A method for producing the microcapsule power of claim 12, the method comprising spray-drying the aqueous mixture comprising the microcapsules and the polymer P.

14. The method of claim 11, comprising drying the resulting board at temperatures in the range from 50 to 250° C.

15. The method of claim 11, comprising drying the resulting board at temperatures in the range from 50 to 150° C.
